(19) United States
(12) Patent Application Publication
(10) Pub. No.: US 2020/0093148 A1
(43) Pub. Date: Mar. 26, 2020

(54) METHOD OF MANUFACTURING FERMENTED MILK CONTAINING PROBIOTICS

(71) Applicant: Seoul F&B Co., Ltd., Gangwon-do (KR)

(72) Inventors: Duk Geun OH, Gangwon-do (KR); Young Soon LIM, Gangwon-do (KR)

(73) Assignee: Seoul F&B Co., Ltd., Gangwon-do (KR)

(21) Appl. No.: 16/136,719

(22) Filed: Sep. 20, 2018

(51) Int. Cl. A23C 9/123; A23C 9/13; C12R 1/25

(52) U.S. Cl. CPC A23C 9/1234; C12R 1/25; A23C 9/1307

(57) ABSTRACT

Provided is a method of preparing fermented milk containing Lactobacillus plantarum SFB1 (KCCM11237P). Owing to rapid production of lactic acid and curd, the fermented milk can significantly reduce fermentation time, maintain high lactic acid bacteria numbers, reduce manufacturing costs, improve production efficiency and provide excellent sensory characteristics.

### BACKGROUND OF THE INVENTION

### Field of the Invention

The present invention relates to a method of manufacturing fermented milk containing probiotics and more particularly, to a method of manufacturing fermented milk containing Lactobacillus plantarum SFB1 (KCCM 11237P).

### Description of the Related Art

Fermented milk is a beverage with excellent flavor that has improved nutritional ingredients, functionality and sensory quality by culturing lactic acid bacteria or yeast in the milk of mammals to ferment lactose and thereby produce lactic acid or alcohol. Thereamong, sour milk refers to fermented milk prepared by lactic acid fermentation and examples thereof include yogurt, cultured buttermilk, acidophilus milk and the like. In addition, alcohol fermented milk refers to fermented milk obtained by fermentation of lactic acid and alcohol through action of lactic acid bacteria and special yeast (lactose-fermenting yeast) and examples thereof include Kefir, Kumiss and the like. In the past, most fermented milk was made from crude milk, but, in recent years, skim milk has often been used as an ingredient.

Korean Industrial Standards (KS) specify that fermented milk is a milky white to yellow homogeneous liquid and has neither off taste nor off flavor, and has a solid-not fat of 3.0% or more and a lactic acid bacteria or yeast count of 10⁷ CFU/mL or more. Concentrated fermented milk refers to a milk or dairy product in the form of a paste or liquid fermented from lactic acid bacteria or yeast. Korean Industrial Standards (KS) specify that concentrated fermented milk has neither off taste nor off flavor, and has a solid-not fat of 8.0% or more and a lactic acid bacteria or yeast count of 10⁸ CFU/mL or more.

Meanwhile, fermented milk is classified into drink type (liquid phase), stud type (paste phase, injecting prepared yogurt into a container) and set type (paste phase, culturing lactic acid bacteria in a container) depending on the preparation method, characteristics and conditions. Most lactic acid bacteria used to manufacture fermented milk products are commercial DVS (direct-vat-set) products. Depending on the characteristics of products, high-temperature or low-temperature fermentation may be conducted. Such a preparation method determines certain quality of products.

Fermentation conducted at a middle or low temperature to manufacture fermented milk products has several advantages of improving flavor and taste of fermented milk and facilitating decomposition of organic substances such as milk proteins, as compared to fermentation conducted at high temperature. However, fermentation at a middle or low temperature takes a long fermentation time, disadvantageously causing increased manufacturing costs and decreased viable lactic acid bacteria counts.

### PRIOR ART

### Patent Document

(Patent Document 1) Korean Patent No. 10-1473634 (Dec. 11, 2014) discloses a novel Lactobacillus genus strain with probiotic activity and a method for preparing a fermented red ginseng using the same, wherein Lactobacillus plantarum SFB1 (KCCM11237P) is used as the novel Lactobacillus genus strain.

(Patent Document 2) Korean Patent No. 10-1174974 (Aug. 10, 2012) discloses a method for preparing fermented milk with improved proliferation of lactic acid bacteria and Bifidobacteria.

### SUMMARY OF THE INVENTION

Therefore, the present invention has been made in view of the above problems, and it is an object of the present invention to develop and provide a method of preparing fermented milk that is highly economically efficient by reducing a fermentation time in spite of conducting main fermentation at a middle or low temperature and is capable of maintaining a high viable lactic acid bacteria count.

In accordance with the present invention, the above and other objects can be accomplished by the provision of a method of preparing fermented milk including mixing a milk (dairy) product containing as a main ingredient, at least one milk ingredient selected from crude milk, skim milk and reduced milk, with refined sugar to prepare a mix solution, followed by sterilizing and cooling (a), inoculating the cooled solution with Lactobacillus plantarum SFB1 (KCCM11237P) (b), subjecting the resulting solution to primary culture (incubation) at 40 to 45° C. for 4 to 10 hours (c), and allowing the solution to be cooled to 35 to 39° C. and subjecting the resulting solution to secondary culture (incubation) for 18 to 28 hours (d).

The method may further include, after step (d), adding sugar syrup to the secondarily cultured solution (e) and homogenizing the resulting mixture at a pressure of 150 to 200 bar (f).

Preferably, the mix solution in step (a) is prepared by mixing a milk product having a solid non-fat of 3.0 to 8.0% (w/w) with refined sugar in a weight ratio of 10:1 to 15:1.

Preferably, the mixing of step (a) is carried out at a temperature of 60 to 65° C.

Preferably, the sterilization of step (a) is carried out at a temperature of 85 to 100° C. for 1 to 3 hours.

Preferably, in step (b), the Lactobacillus plantarum SFB1 (KCCM11237P) may be simultaneously inoculated in combination with direct vat set (DVS) lactic acid bacteria.

Preferably, the sugar syrup is prepared by mixing purified water, high-concentration fructose and honey in a weight ratio of 2 to 3:1:0.01 to 0.03, and then sterilizing the resulting mixture at 120 to 140° C. for 15 to 60 seconds.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a process for preparing fermented milk according to the present invention;

FIG. 2 shows evaluation results of viable cell numbers of Lactobacillus plantarum SFB1 (KCCM11237P) and direct vat set (DVS) lactic acid bacteria;

FIG. 3 shows evaluation results of acid resistance of Lactobacillus plantarum SFB1 (KCCM11237P) and direct vat set (DVS) lactic acid bacteria;

FIG. 4 shows evaluation results of availability of Lactobacillus plantarum SFB1 (KCCM11237P) as a starter;

FIG. 5 shows evaluation results of pH changes of Lactobacillus plantarum SFB1 (KCCM11237P) and direct vat set (DVS) lactic acid bacteria; and

FIG. 6 shows results of sensory evaluation regarding fermented milk prepared by culturing a combination of Lactobacillus plantarum SFB1 (KCCM11237P) according to the present invention and direct vat set (DVS) lactic acid bacteria, and control group fermented milk fermented only from DVS lactic acid bacteria.

### DETAILED DESCRIPTION OF THE INVENTION

The present invention provides a method of preparing fermented milk including mixing a milk (dairy) product containing as a main ingredient, at least one milk ingredient selected from crude milk, skim milk and reduced milk, with refined sugar to prepare a solution, followed by sterilizing and cooling (a), inoculating the cooled solution with Lactobacillus plantarum SFB1 (KCCM11237P) (b), subjecting the resulting solution to primary culture (incubation) at 40 to 45° C. for 4 to 10 hours (c), and allowing the solution to be cooled to 35 to 39° C. and subjecting the resulting solution to secondary culture (incubation) for 18 to 28 hours (d).

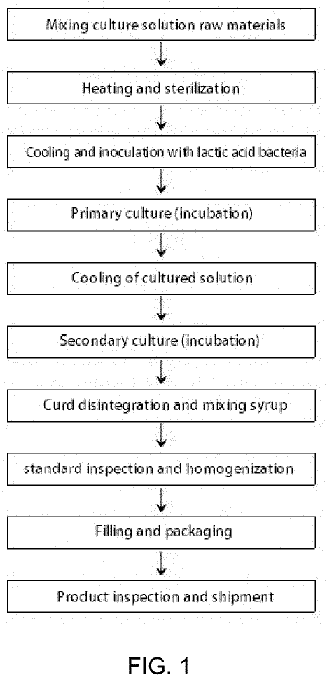

Meanwhile, the present invention may further include, after step (d), adding sugar syrup to the secondarily cultured solution (e) and then homogenizing the resulting mixture at a pressure of 150 to 200 bar (f) (see FIG. 1). FIG. 1 is a schematic diagram illustrating a process for preparing fermented milk according to the present invention.

Hereinafter, respective steps of the present invention will be described in more detail.

<Step (a): Preparation of Solution>

In the present step, a milk (dairy) product containing, as a main ingredient, at least one milk ingredient selected from crude milk, skim milk and reduced milk, is mixed with refined sugar to prepare a mix solution, followed by sterilizing and cooling.

The mix solution of the present step is preferably prepared by mixing a milk product having a solid non-fat content of 3.0 to 8.0% (w/w) with refined sugar in a weight ratio of 10:1 to 15:1. The solid non-fat content refers to a solid content obtained by subtracting a fat content from the total solid content of milk. In the Korean Food Standards Codex, lactic acid bacteria-fermented milk is classified into liquid fermented milk (3.0% or more) and concentrated fermented milk (8.0% or more), depending on solid not-fat content. In the present invention, skim milk having a solid non-fat content of 3.0 to 8.0% (w/w) is used to manufacture any one selected from liquid fermented milk and concentrated fermented milk.

Meanwhile, the mixing in the present step is preferably carried out at a temperature of 60 to 65° C. The reason for this is that, when the mixing is carried out at a temperature lower than 60° C., a homogenous mix solution cannot be obtained due to low solubility of the mixture, and when the mixing is carried out at a temperature higher than 65° C., it is disadvantageously difficult to obtain a homogeneous mix solution because a coating film may be formed by a powder or the like.

Meanwhile, the sterilization in the present step is preferably performed at 85 to 100° C. for 1 to 3 hours. The reason for this is that the present heating results in heating change of whey protein, induction of Maillard reaction and removal of harmful bacteria in the mix solution.

Meanwhile, the cooling in the present step is preferably performed at 40 to 45° C., because cooling the sterilized mix solution to 40 to 45° C. can facilitate fermentation of lactic acid bacteria in the subsequent fermentation process. The reason for this is that, when the cooling temperature is lower than 40° C., elevating to a temperature suitable for incubating Lactobacillus plantarum SFB1 (KCCM11237P) is needed or the incubation time is delayed, thus disadvantageously causing inefficiency of costs and time, and when the cooling temperature is higher than 45° C., disadvantageously, survival of lactic acid bacteria is not suited, taste of fermented milk is changed and flavor is deteriorated.

<Step (b): Inoculation with Lactic Acid Bacteria>

In the present step, the cooled mix solution is inoculated with Lactobacillus plantarum SFB1 (KCCM11237P) after step (a).

The Lactobacillus plantarum SFB1 (KCCM11237P) used in the present step is the strain disclosed in Korean Patent No. 10-1473634 owned by the present inventor.

Meanwhile, in the present step, preferably, the mix solution may be simultaneously inoculated with Lactobacillus plantarum SFB1 (KCCM11237P) and direct vat set (DVS) lactic acid bacteria.

The direct vat set (DVS) lactic acid bacteria used in the present step are commercially available mesophilic lactic acid bacteria (from JUPITER INTERNATIONAL CO., LTD.), which can be used immediately without subculture. The direct vat set (DVS) lactic acid bacteria are efficient for reducing costs for preserving starters, loss by contamination and decrease in bacterial activity.

Meanwhile, in the present step, preferably Lactobacillus plantarum SFB1 (KCCM11237P) and DVS (direct vat set) lactic acid bacteria are mixed at the equivalent level of about 10⁶ CFU/mL, and are added in a ratio of 1:1 on a viable cell count basis to the mix solution. When the mix solution is inoculated with two types of lactic acid bacteria mixed in this ratio, the viable bacteria count is maintained well, and the best sensory evaluation results and the best effect of shortening the fermentation time as compared to costs are obtained. More preferably, the mixture of the two types of bacteria is added in an amount of 0.0001 to 0.001% to the mix solution, based on the weight of the mix solution, on a dry matter basis.

In the present step, preferably, a combination of Lactobacillus plantarum SFB1 (KCCM11237P) and direct vat set (DVS) lactic acid bacteria is used, because stirring is required for thorough mixing, when lactic acid bacteria (DVS) should be added again for secondary incubation (culture) after primary incubation (culture), and upon application of this physical shock, the curd of the cultured liquid is disintegrated, and layer separation involving precipitation of casein proteins occurs, which results in deteriorated growth of lactic acid bacteria and thus yields unsuitable fermented products.

<Step (c): Primary Culture (Incubation)>

In the present step, after step (b), primary culture (incubation) is conducted at 40 to 45° C. for 4 to 10 hours. By facilitating growth of Lactobacillus plantarum SFB1 (KCCM11237P) through this step, weak-acidic (pH of about 4.85) primary fermented milk can be obtained.

In the present step, when culture is carried out at a temperature lower than 40° C., deteriorated activity of the lactic acid bacteria disadvantageously results in lowered production efficiency over time and deteriorated flavor of fermented milk. In addition, culture (incubation) at a temperature higher than 45° C. is not preferred because growth of lactic acid bacteria is unstable due to high-temperature shock.

<Step (d): Cooling and Secondary Culture (Incubation)>

In the present step, after step (c), the resulting mix solution was allowed to cool to 35 to 39° C. and subjected to secondary culture (incubation) for 18 to 28 hours. At this time, the cooling is preferably carried out at a temperature of 35 to 39° C. using cooling water. In the present step, the primary fermented milk prepared in step (c) is cooled to 35 to 39° C. for favorable fermentation of mesophilic bacteria during secondary incubation. By facilitating growth of direct vat set (DVS) lactic acid bacteria though this process, secondary fermented milk having a pH higher than about 3.65 can be prepared.

When culture (incubation) is carried out at a temperature lower than 35° C. in the present step, slow growth of the lactic acid bacteria may entail a longer incubation time and other metabolites are produced, which may negatively affect sensory quality. In addition, thermophilic bacteria are continuously grown at a temperature higher than 39° C., which may accelerate production of lactic acid, but may have a problem of deteriorated decomposition of milk protein.

Rapid formation of lactic acid and curd through steps (a) to (d) can significantly shorten fermentation time, maintain high lactic acid bacteria counts, reduce manufacturing costs, improve production efficiency and enable production of fermented milk with excellent sensory characteristics.

Meanwhile, in accordance with the method of the present invention, preferably, steps (e) and (f) described below may be further conducted after step (d), which enables preparation of fermented milk with much better sensory characteristics. Steps (e) and (f) will be described in more detail below.

<Step (e): Addition of Sugar Syrup>

In the present step, sugar syrup is added to the secondarily fermented solution, after step (d).

The sugar syrup is preferably prepared by mixing purified water, high-concentration fructose and honey in a weight ratio of 2 to 3:1:0.01 to 0.03, and sterilizing the resulting mixture at 120 to 140° C. for 15 to 60 seconds. The sugar syrup prepared under these conditions is homogeneously mixed so that it can exhibit advantages suitable for use for fermented milk.

<Step (f): Homogenizing Treatment>

In the present step, after step (e), the resulting mixture is homogenized at a pressure of 150 to 200 bar. Through the homogenizing treatment, perfect fermented milk could be prepared. Homogenization at a pressure of 150 to 200 bar enables fermented milk to have a uniform particle size, minimizes feeling of irritation and facilitates digestion. A method for homogenization according to the present invention is not particularly limited.

Hereinafter, the configuration of the present invention will be described in more detail with reference to the following Preparation Example, Example and Test Example. The scope of the present invention is not limited to the Preparation Example, Example and Test Example, and includes modifications of the technical concept equivalent thereto.

### TEST EXAMPLE 1

### Suitability of Lactobacillus plantarum SFB1 (KCCM11237P) Strains for the Present Invention

The present test was conducted to identify whether or not Lactobacillus plantarum SFB1 (KCCM11237P), that is, the target of the present invention, was a strain suitable for the aim of the present invention, that is, fermentation time reduction.

(1) Identification of Viable Cell Number Depending on Incubation Time

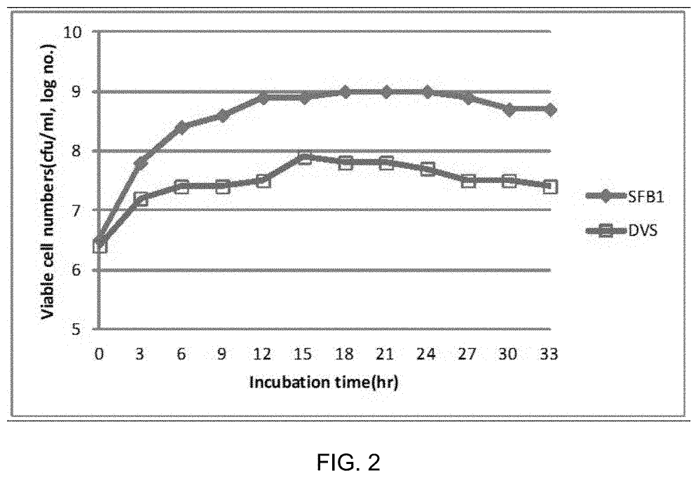

MRS liquid medium was inoculated with the probiotic lactic acid bacteria, that is, Lactobacillus plantarum SFB1 (KCCM11237P) according to the present invention and direct vat set (DVS) lactic acid bacteria at 1.0×10⁶ CFU/mL, Lactobacillus plantarum SFB1 (KCCM11237P) according to the present invention were primarily cultured (incubated) at 42° C. until an incubation time of 6 hours and then secondarily cultured (incubated) at 38° C. after the incubation time of 6 hours, DVS lactic acid bacteria were cultured (incubated) at 38° C. and at the same time, change behaviors of viable cell numbers depending on incubation time were evaluated. (Table 1, FIG. 2). FIG. 2 shows evaluation results of viable cell numbers of Lactobacillus plantarum SFB1 (KCCM11237P) and direct vat set (DVS) lactic acid bacteria.

TABLE 1
Changes of viable cell numbers in MRS liquid medium

| Incubation time | SFB1 | DVS lactic acid bacteria |
|---|---|---|
| 0 | 6.5 ± 0.3 | 6.4 ± 0.2 |
| 3 | 7.8 ± 0.2 | 7.2 ± 0.4 |
| 6 | 8.4 ± 0.6 | 7.4 ± 0.3 |
| 9 | 8.6 ± 0.4 | 7.4 ± 0.3 |
| 12 | 8.9 ± 0.4 | 7.5 ± 0.5 |
| 15 | 8.9 ± 0.3 | 7.9 ± 0.5 |
| 18 | 9.0 ± 0.4 | 7.8 ± 0.3 |
| 21 | 9.0 ± 0.2 | 7.8 ± 0.3 |
| 24 | 9.0 ± 0.4 | 7.7 ± 0.4 |
| 27 | 8.9 ± 0.4 | 7.5 ± 0.3 |
| 30 | 8.7 ± 0.3 | 7.5 ± 0.4 |
| 33 | 8.7 ± 0.3 | 7.4 ± 0.3 |

Test results showed that the Lactobacillus plantarum SFB1 (KCCM11237P) according to the present invention showed a continuous increase in viable cell number to 1.0×10⁹ CFU/mL during incubation for 18 hours and a high viable cell number of 5.0×10⁸ CFU/mL even after fermentation for 33 hours. On the other hand, the number of DVS lactic acid bacteria increased up to 3.1×10⁷ CFU/mL at maximum after incubation for 15 hours, and then was maintained.

(2) Evaluation of Acid Resistance

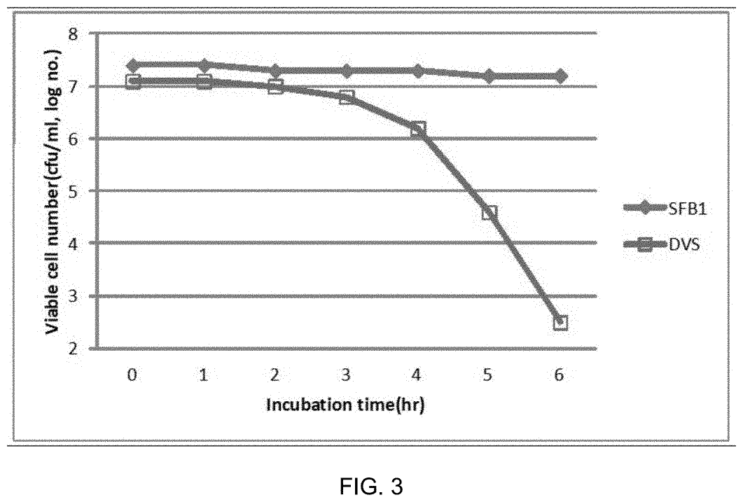

In order to evaluate acid resistance of the Lactobacillus plantarum SFB1 (KCCM11237P) according to the present invention and direct vat set (DVS) lactic acid bacteria, an MRS liquid medium adjusted to pH of 3.5 was prepared with 1N-HCl, the medium was inoculated with 2.4×10⁷ CFU/mL of lactic acid bacteria, and viable cell numbers were checked, while incubating at 38° C. (Table 2, FIG. 3). FIG. 3 shows evaluation results of acid resistance of Lactobacillus plantarum SFB1 (KCCM11237P) and direct vat set (DVS) lactic acid bacteria.

TABLE 2
Changes of viable cell numbers in pH 3.5 MRS liquid
medium

| Incubation time | SFB1 | DVS lactic acid bacteria |
|---|---|---|
| 0 | 7.4 ± 0.2 | 7.1 ± 0.2 |
| 1 | 7.4 ± 0.5 | 7.1 ± 0.2 |
| 2 | 7.3 ± 0.4 | 7.0 ± 0.3 |
| 3 | 7.3 ± 0.2 | 6.8 ± 0.2 |
| 4 | 7.3 ± 0.4 | 6.2 ± 0.2 |
| 5 | 7.2 ± 0.4 | 4.6 ± 0.4 |
| 6 | 7.2 ± 0.2 | 2.5 ± 0.5 |

Test results showed that the Lactobacillus plantarum SFB1 (KCCM11237P) according to the present invention had almost no decrease in viable cell number until the incubation time of 6 hours and thus exhibited excellent acid resistance, while DVS lactic acid bacteria had a rapid decrease in viable cell number after incubation for 3 hours.

(3) Identification of Availability for Fermented Milk Starter

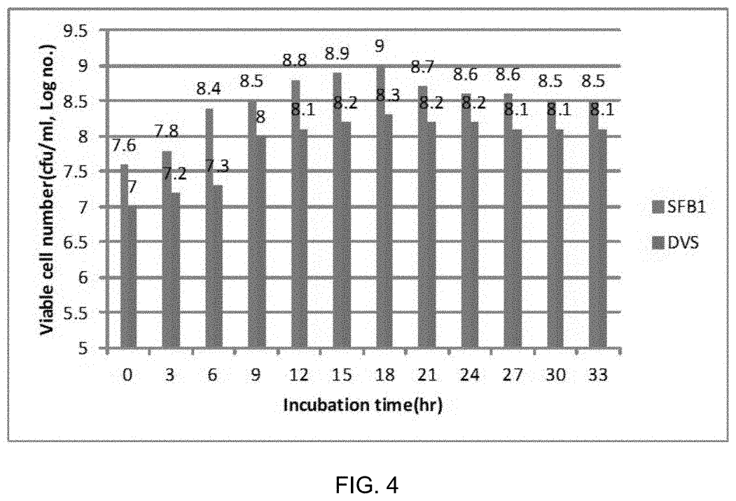

In order to identify availability of Lactobacillus plantarum SFB1 (KCCM11237P) of the present invention as a fermented milk starter, the Lactobacillus plantarum SFB1 (KCCM11237P) according to the present invention and DVS lactic acid bacteria were each inoculated to prepare mix solutions containing skim milk having a milk solid content of 8%, the mix solutions were incubated at 40° C. and viable cell numbers at different times were counted (Table 3, FIG. 4). FIG. 4 shows evaluation results of availability of Lactobacillus plantarum SFB1 (KCCM11237P) as a starter.

TABLE 3
Changes of viable cell numbers during incubation in
skim milk-combined fermentation solution

| Incubation time | SFB1 | DVS lactic acid bacteria |
|---|---|---|
| 0 | 7.6 ± 0.4 | 7.0 ± 0.2 |
| 3 | 7.8 ± 0.2 | 7.2 ± 0.2 |
| 6 | 8.4 ± 0.4 | 7.3 ± 0.5 |
| 9 | 8.5 ± 0.4 | 8.0 ± 0.4 |
| 12 | 8.8 ± 0.5 | 8.1 ± 0.4 |
| 15 | 8.9 ± 0.3 | 8.2 ± 0.3 |
| 18 | 9.0 ± 0.2 | 8.3 ± 0.4 |
| 21 | 8.7 ± 0.4 | 8.2 ± 0.4 |
| 24 | 8.6 ± 0.3 | 8.2 ± 0.5 |
| 27 | 8.6 ± 0.4 | 8.1 ± 0.3 |
| 30 | 8.5 ± 0.2 | 8.1 ± 0.4 |
| 33 | 8.5 ± 0.4 | 8.1 ± 0.4 |

The Lactobacillus plantarum SFB1 (KCCM11237P) according to the present invention, similar to in the MRS medium, had a rapid increase in viable cell number after incubation for 6 hours and a continuous increase in viable cell number up to an incubation time of 18 hours, and the viable cell number at the incubation time of 30 hours was relatively high, that is, 3.1×10⁸ CFU/mL. On the other hand, DVS lactic acid bacteria had the greatest increment in viable cell number at an incubation time of 9 hours, and had a viable cell number of 1.3×10⁸ CFU/mL at an incubation time of 30 hours. That is, the Lactobacillus plantarum SFB1 (KCCM11237P) according to the present invention maintained excellent growth rate as well as high viable cell number.

(4) Identification of pH Change Depending on Incubation Time

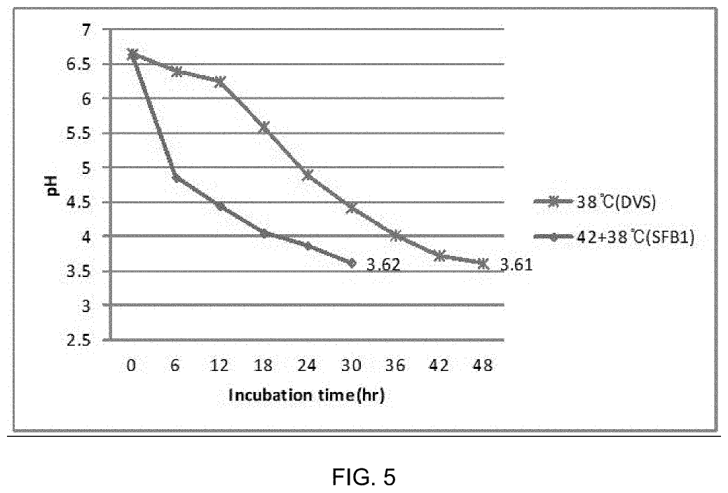

The Lactobacillus plantarum SFB1 (KCCM11237P) according to the present invention were primarily cultured (incubated) at 42° C. until an incubation time of 6 hours and secondarily incubated at 38° C. after the incubation time of 6 hours, and DVS lactic acid bacteria were cultured (incubated) 38° C. and at the same time, the pH change of the mix solution was evaluated (Table 4, FIG. 5). FIG. 5 shows evaluation results of pH changes of Lactobacillus plantarum SFB1 (KCCM11237P) and direct vat set (DVS) lactic acid bacteria.

TABLE 4
pH change

| Incubation time | SFB1 | DVS lactic acid bacteria |
|---|---|---|
| 0 | 6.65 | 6.65 |
| 6 | 4.86 | 6.4 |
| 12 | 4.45 | 6.25 |
| 18 | 4.05 | 5.6 |
| 24 | 3.87 | 4.9 |
| 30 | 3.62 | 4.42 |
| 36 | — | 4.02 |
| 42 | — | 3.73 |
| 48 | — | 3.61 |

Test results showed that the Lactobacillus plantarum SFB1 (KCCM11237P) according to the present invention showed a great pH drop at an incubation time of 6 hours and had a pH of 3.65 or less, which means an incubation termination level, after an incubation time of 80 hours. On the other hand, the DVS lactic acid bacteria reached a pH of 3.65 or less, which means an incubation termination level, after an incubation time of 48 hours.

The aforementioned test identified that Lactobacillus plantarum SFB1 (KCCM11237P), the target strain of the present invention, can significantly reduce fermentation time and maintain high lactic acid bacteria numbers. Fermented milk was prepared in accordance with the following Example.

### EXAMPLE 1

### Fermented Milk of the Present Invention

In order to prepare fermented milk of the present invention, 50 kg of refined sugar was mixed with 600 kg of skim milk with a solid non-fat content of 7.5% (w/w), followed by thoroughly mixing at a temperature of 65° C. The resulting mixture was heated to 85° C. or higher for one hour and sterilized to prepare a mix solution. Then, the mix solution was allowed to cool to 42° C., and 0.0005% (w/w, on a dry matter basis) of a bacterial combination of Lactobacillus plantarum SFB1 and DVS lactic acid bacteria mixed in a ratio of 1:1, based on the viable cell number, was added to the mix solution. Then, the resulting mixture was fermented at 42° C. for 6 hours, primarily cultured (incubated) such that pH reached 5.0 or less, cooled with cooling water and then secondarily cultured (incubated) at 38° C. for 24 hours such that pH reached 3.65 or less to prepare a fermented solution.

The cultured (incubated) mix solution, that is, fermented solution, was mixed in the equivalent ratio with a syrup prepared by mixing 248 kg of purified water, 100 kg of high-concentration fructose and 2 kg of honey and then sterilizing the resulting mixture at 120° C. for 15 seconds, to prepare a 15 Brix fermented milk mix solution. Then, the fermented milk solution was homogenized at a pressure of 15 bar to prepare fermented milk according to the present invention.

Meanwhile, as a control group, fermented milk was prepared in the same manner as in the fermented milk of the present invention except that only general mesophilic bacteria and DVS lactic acid bacteria were incubated at 38° C. for 47 hours, which was used for the following test.

### TEST EXAMPLE 2

### Sensory Evaluation

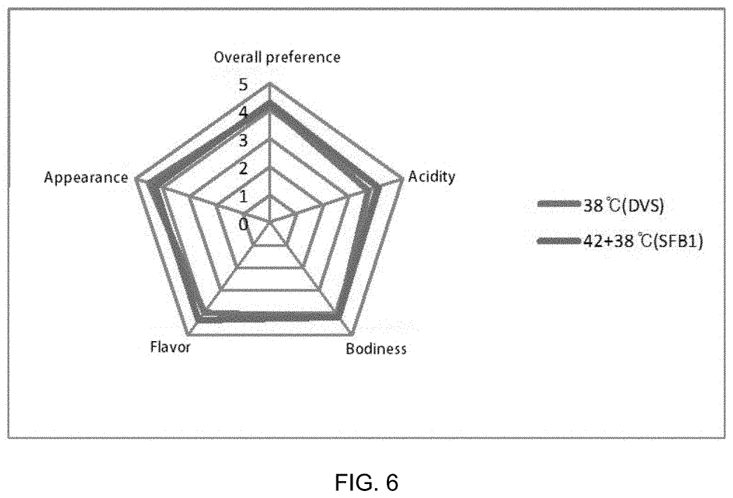

The fermented milk according to the present invention prepared in Example 1 and fermented milk as the control group were subjected to sensory evaluation. For sensory evaluation, researchers in the laboratory in Seoul F&B Co., Ltd., and inspectors of Food Safety Headquarters were selected (n=15), and testing was based on a five-score method ranging from very good (5) to very bad (1) in terms of acidity (sour taste), bodiness, flavor, appearance and overall preference (Table 5, FIG. 6). FIG. 6 shows results of sensory evaluation regarding fermented milk prepared by culturing a combination of Lactobacillus plantarum SFB1 (KCCM11237P) according to the present invention and direct vat set (DVS) lactic acid bacteria, and control group fermented milk fermented only from DVS lactic acid bacteria.

TABLE 5

| | Overall | | | | |
|---|---|---|---|---|---|
| | preference | Acidity | Bodiness | Flavor | Appearance |
| DVS lactic | 4.2 | 3.7 | 4.2 | 4.0 | 4.5 |
| acid bacteria | | | | | |
| SFB1 + DVS | 4.3 | 4.1 | 4.2 | 4.3 | 4.3 |
| lactic acid | | | | | |
| bacteria | | | | | |

Evaluation results showed the control group fermented at a low temperature for a long time was considered to be relatively poor in terms of acidity, while the fermented milk of the present invention had a high score of 4.0 or more.

As is apparent from the above description, owing to rapid production of lactic acid and curd, the fermented milk according to the present invention can significantly reduce fermentation time, maintain high lactic acid bacteria numbers, reduce manufacturing costs, improve production efficiency and provide excellent sensory characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing fermented milk comprising:
mixing a milk (dairy) product containing, as a main ingredient, at least one milk ingredient selected from crude milk, skim milk and reduced milk, with refined sugar to prepare a solution, followed by sterilizing and cooling (a);
inoculating the cooled solution with Lactobacillus plantarum SFB1 (KCCM11237P) (b);
subjecting the resulting solution to primary culture (incubation) at 40 to 45° C. for 4 to 10 hours (c); and
allowing the solution to be cooled to 35 to 39° C. and subjecting the resulting solution to secondary culture (incubation) for 18 to 28 hours (d).

2. The method according to claim 1, further comprising:
after step (d), adding sugar syrup to the secondarily cultured solution (e); and
homogenizing the resulting mixture at a pressure of 150 to 200 bar (f).

3. The method according to claim 1, wherein the mix solution in step (a) is prepared by mixing a milk product having a solid non-fat of 3.0 to 8.0% (w/w) with refined sugar in a weight ratio of 10:1 to 15:1.

4. The method according to claim 1, wherein the mixing of step (a) is carried out at a temperature of 60 to 65° C.

5. The method according to claim 1, wherein the sterilization of step (a) is carried out at a temperature of 85 to 100° C. for 1 to 3 hours.

6. The method according to claim 1, wherein, in step (b), the Lactobacillus plantarum SFB1 (KCCM11237P) is simultaneously inoculated in combination with direct vat set (DVS) lactic acid bacteria.

7. The method according to claim 2, wherein the sugar syrup is prepared by mixing purified water, high-concentration fructose and honey in a weight ratio of 2 to 3:1:0.01 to 0.03, and then sterilizing the resulting mixture at 120 to 140° C. for 15 to 60 seconds.
